(19) United States
(12) Patent Application Publication
(10) Pub. No.: US 2014/0241560 A1
(43) Pub. Date: Aug. 28, 2014

(54) HEADSET

(71) Applicant: FUNAI ELECTRIC CO., LTD., Osaka (JP)

(72) Inventor: Noriyuki SHIMIZU, Osaka (JP)

(73) Assignee: FUNAI ELECTRIC CO., LTD., Osaka (JP)

(21) Appl. No.: 14/178,426

(22) Filed: Feb. 12, 2014

(30) Foreign Application Priority Data
Feb. 22, 2013 (JP) 2013-032823

(51) Int. Cl. H04R 1/10

(52) U.S. Cl. CPC H04R 1/1091
USPC 381/375

(57) ABSTRACT

A headset includes an enclosure holding a speaker and a microphone. The enclosure includes: a main body portion which holds the speaker and in which an earphone portion attached to an ear is provided; a microphone holding portion which holds the microphone; and a coupling portion which couples the main body portion to the microphone holding portion. When a side where the earphone portion is provided is a front surface side of the enclosure, in a side surface portion of the microphone holding portion, a sound hole communicating with the microphone is formed.

This application is based on Japanese Patent Application No. 2013-032823 filed on Feb. 22, 2013, the contents of which are hereby “incorporated by reference.”

### BACKGROUND OF THE INVENTION

1. Field of the Invention

The present invention relates to a headset, and more particularly relates to a headset including a microphone and a speaker.

2. Description of Related Art

Conventionally, headsets including a microphone and an earphone speaker are known (for example, see JP-T-2010-505317)

JP-T-2010-505317 discloses a communication headset that includes a housing (enclosure) having a speaker, a microphone and an earpiece. In the communication headset, the earpiece can be adjusted to be suitable for the size of an ear of a speaking person.

### SUMMARY OF THE INVENTION

However, in JP-T-2010-505317, since the sound hole of the speaker and the sound hole of the microphone are formed in the same surface of the housing, the sound hole of the microphone is likely to be blocked by the cheek of the speaking person. When the sound hole of the microphone is blocked, the sensitivity of the microphone is lowered, and thus it is disadvantageously impossible to pick up sound produced by the speaking person.

A headset is also known in which a microphone is held in an arm head at an end of a boom arm. In such a headset, the shape of the arm head is greatly affected by the direction in which the microphone is arranged, and thus its design may be degraded.

An object of the present invention is to provide a headset in which a sound hole communicating with a microphone is unlikely to be blocked by the cheek of a speaking person, in which thus the sensitivity of the microphone is maintained satisfactory and which has a good design.

To achieve the above object, according to the present invention, there is provided a headset that includes an enclosure holding a speaker and a microphone, where the enclosure includes: a main body portion which holds the speaker and in which an earphone portion attached to an ear is provided; a microphone holding portion which holds the microphone; and a coupling portion which couples the main body portion to the microphone holding portion, and when a side where the earphone portion is provided is a front surface side of the enclosure, in a side surface portion of the microphone holding portion, a sound hole communicating with the microphone is formed.

In this configuration, since in the side surface portion of the microphone holding portion, the sound hole communicating with the microphone is formed, when the headset is fitted to the speaking person, the sound hole is unlikely to be blocked by the cheek of the speaking person. Thus, it is possible to maintain a satisfactory sensitivity of the microphone. By providing the sound hole in the side surface portion, it is possible to change the direction of arrangement of the microphone from the conventional direction, and to make the microphone holding portion appear thin when seen from the front side, with the headset fitted to the speaking person. In other words, with this configuration, it is possible to provide the headset in which a good design is provided.

Preferably, in the headset described above, the microphone holding portion includes two side surface portions which are substantially parallel to a direction in which the coupling portion extends out from the main body portion, and the sound hole is formed in at least one of the two side surface portions. With this configuration, it is possible to easily provide the headset that makes the microphone holding portion appear thin when seen from the front side, with the headset fitted to the speaking person.

Preferably, in the headset described above, the microphone includes a substrate which is provided substantially parallel to the one of the side surface portions where the sound hole is formed. With this configuration, it is possible to reduce the distance between the two side surface portions to make the microphone holding portion appear thin.

Preferably, in the headset described above, the two side surface portions are opposite each other such that a distance between the side surface portions is narrowed as the side surface portions extend to the front surface side.

In this configuration, at the time of assembly, the microphone can be inserted from the side where the distance between the two side surface portions is wider. In other words, with this configuration, it is possible to expect that the microphone is easily inserted and the headset is easily assembled.

Preferably, in the headset described above, the microphone holding portion is formed by assembling a first member and a second member together, the first member is an integrally molded member which includes the two side surface portions and a front surface portion that couples the two side surface portions and the second member is a member which includes a back surface portion provided on an opposite side to the front surface portion.

In this configuration, since the members of the microphone holding portion are two components, that is, the first and second members, it is possible to realize the minimum number of components and also reduce the number of assembly steps. At the time of assembly, the second member is only fitted into the first member after the differential microphone is adhered or placed therewithin, and thus the assembly is easily performed. The microphone holding member is not separated into left and right parts, and thus a division line is invisible, with the result that a good design is provided.

Preferably, the headset described above includes a microphone fixing member which presses the microphone onto the side surface portion where the sound hole is formed.

In this configuration, since the microphone holding member can press the microphone onto the side surface portion where the sound hole is formed, and thereby can fix it, it is possible to easily prevent sound leakage by combination with, for example, a gasket or the like.

Preferably, in the headset described above, the microphone fixing member is molded integrally with the microphone holding member.

With this configuration, it is possible to realize the minimum number of components and also reduce the number of assembly steps.

Preferably, in the headset described above, the microphone is a differential microphone which has two microphone sound holes, and the number of the sound holes formed in the microphone holding portion is two.

With this configuration, it is possible to mount, on the headset, a differential microphone having two sound holes.

In the present invention, it is possible to provide a headset in which a sound hole communicating with a microphone is likely to be blocked by the cheek of a speaking person, in which thus the sensitivity of the microphone is maintained satisfactory and which has a good design.

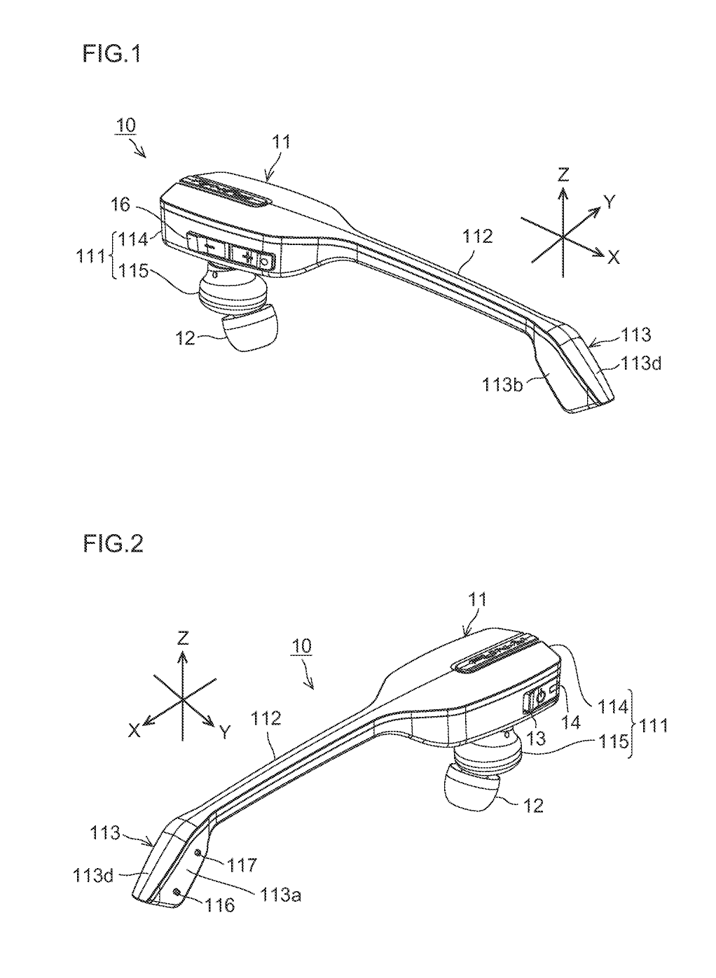

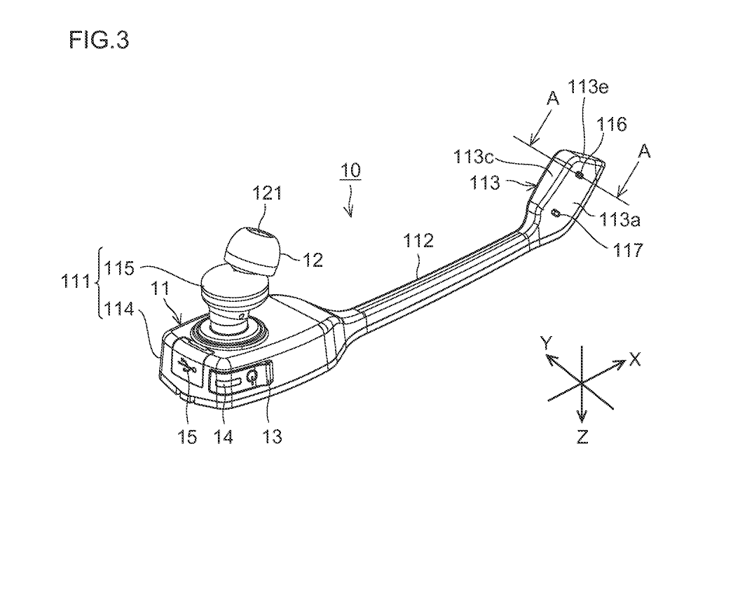

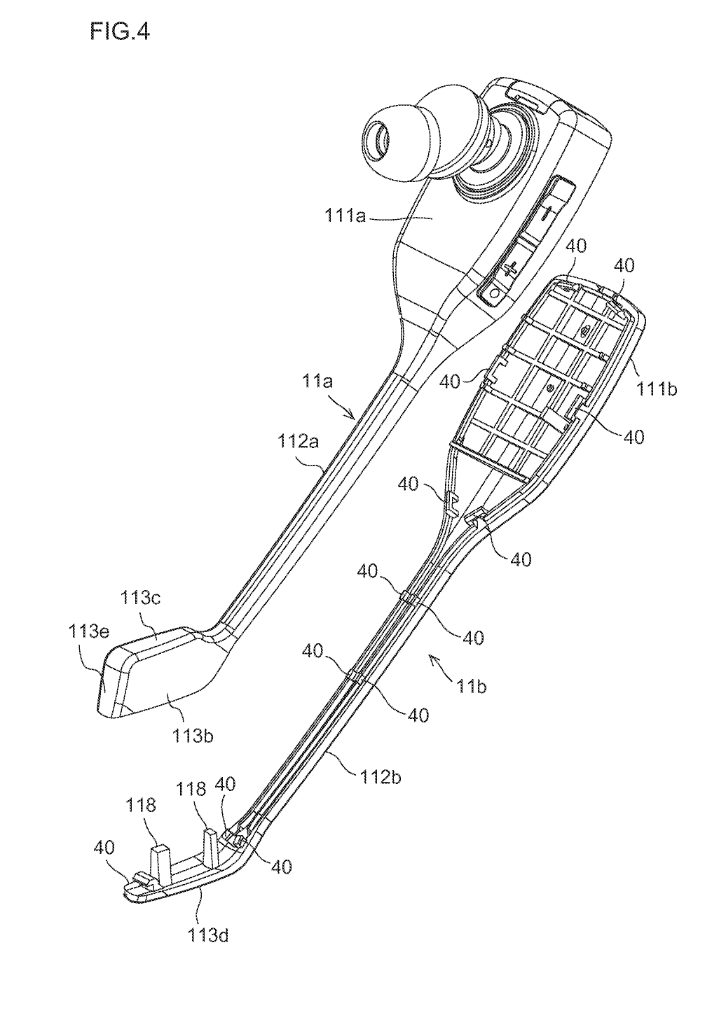

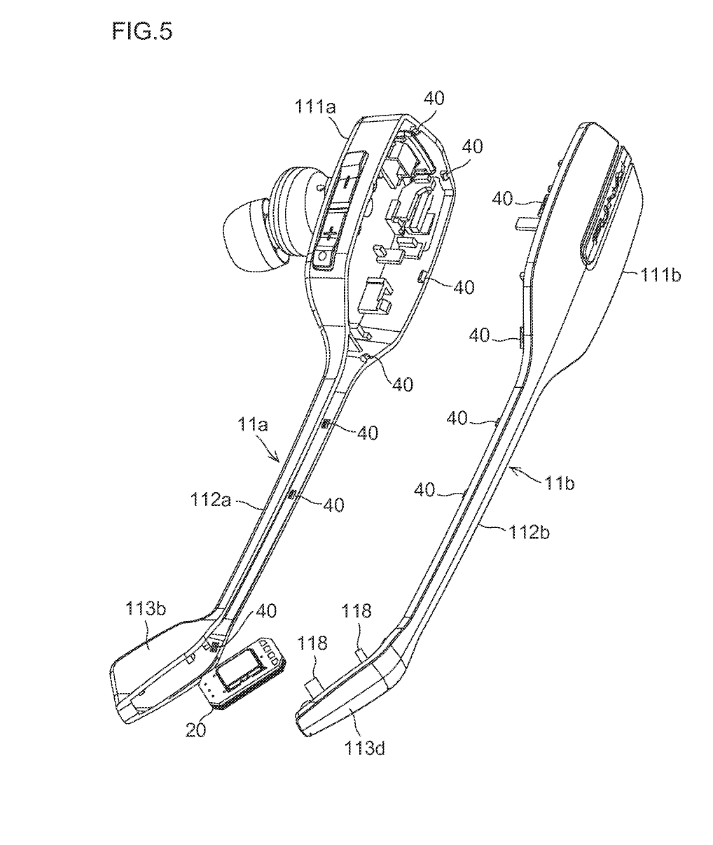

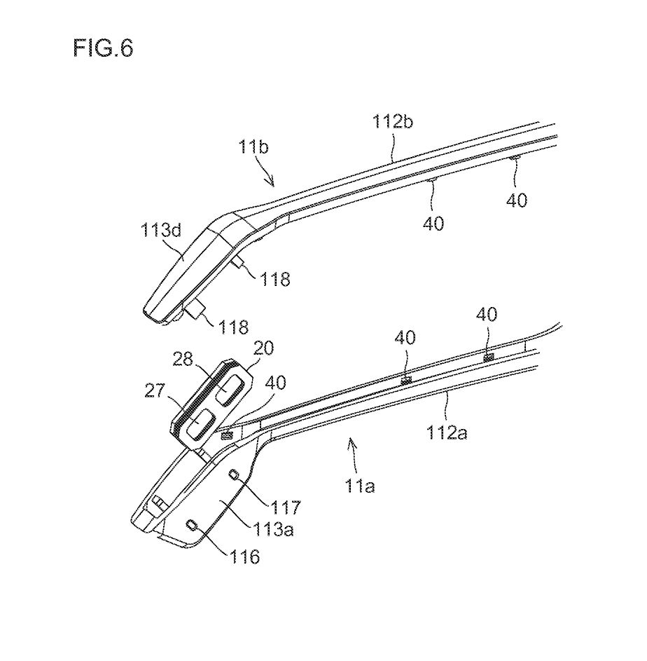

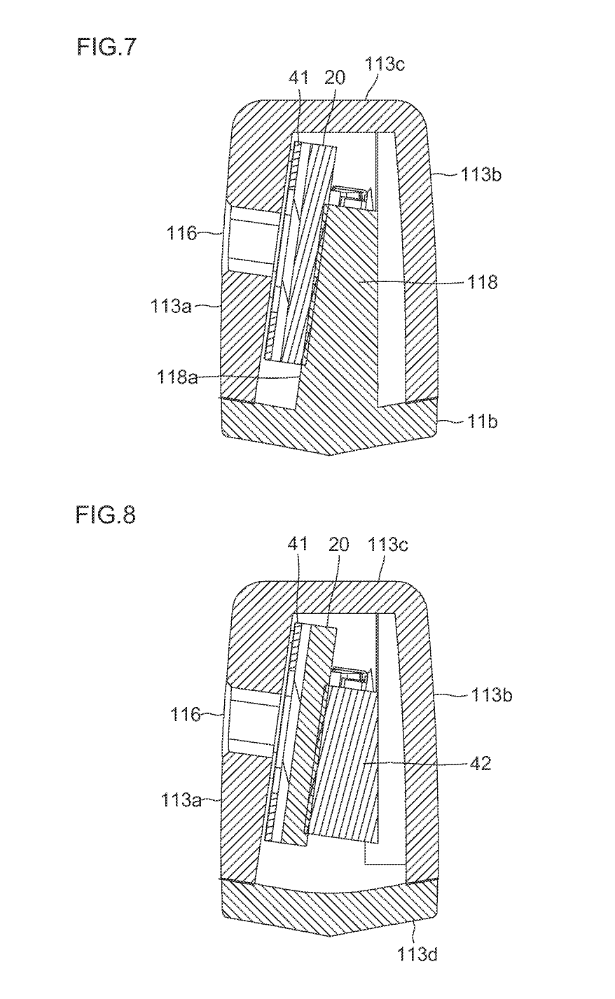

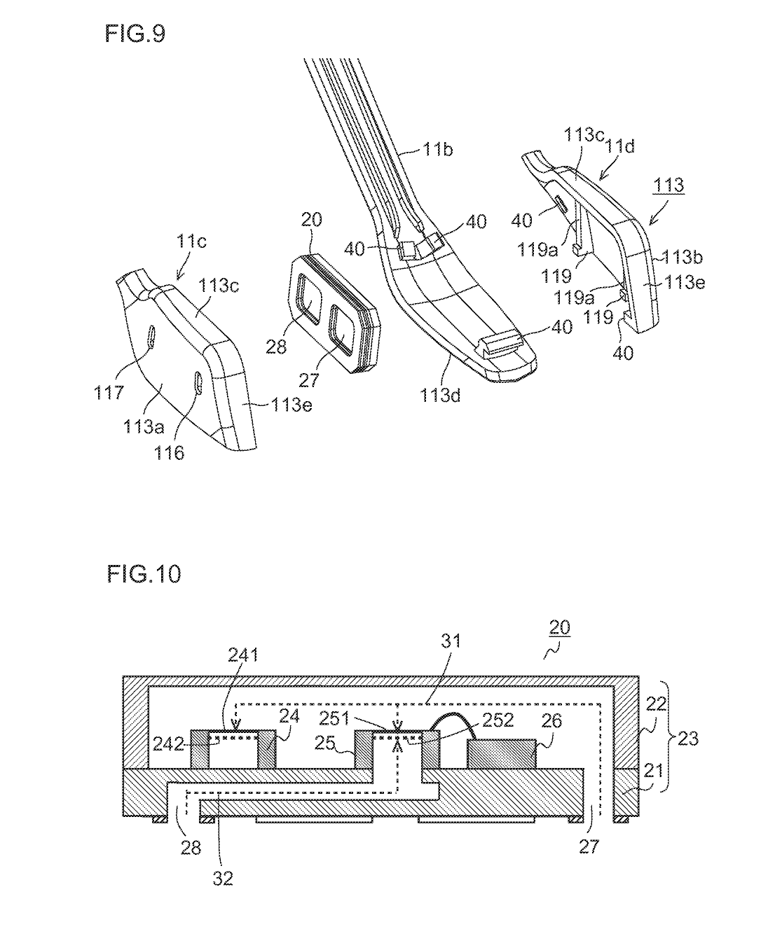

### BRIEF DESCRIPTION OF THE DRAWINGS

[FIG. 1] A perspective view of a headset according to a first embodiment of the present invention;

[FIG. 2] A perspective view of the headset according to the first embodiment of the present invention;

[FIG. 3] A perspective view of the headset according to the first embodiment of the present invention;

[FIG. 4] An exploded perspective view of the headset according to the first embodiment of the present invention;

[FIG. 5] An exploded perspective view of the headset according to the first embodiment of the present invention;

[FIG. 6] An exploded perspective view of part of the headset according to the first embodiment of the present invention;

[FIG. 7] A cross-sectional view taken along line A-A of FIG. 3;

[FIG. 8] A cross-sectional view of an arm head portion in a headset according to a second embodiment of the present invention;

[FIG. 9] An exploded perspective view of the arm head portion and its vicinity in a headset according to a third embodiment;

[FIG. 10] A cross-sectional view of an example of a differential microphone.

### DETAILED DESCRIPTION OF PREFERRED EMBODIMENTS

Embodiments of the present invention will be described below with reference to accompanying drawings. The embodiments and detailed variations of the embodiments can be combined as long as they are achieved.

### First Embodiment

FIGS. 1 to 3 are perspective views of a headset according to a first embodiment; FIGS. 4 and 5 are exploded perspective views of the headset according to the first embodiment; FIG. 6 is an exploded perspective view of part of the headset according to the first embodiment; and FIG. 7 is a cross-sectional view taken along line A-A of FIG. 3. In FIGS. 1 to 3, X, Y and Z axes are added in which the directions of arrows indicate positive directions. FIGS. 4 to 6 show only main configurations that will be described below.

As shown in FIGS. 1 to 3, the headset 10 includes an enclosure 11, an ear pad 12, a multifunctional button 13, an LED (light emitting diode) lamp 14, a charging terminal 15 and a volume button 16. The headset 10 is the type that is attached to an ear of a speaking person An ear book for preventing the headset 10 from dropping from the ear may be provided. As the ear hook, for example, a rubber ring that is provided around the ear pad 12 can be used.

The ear pad 12 is a member that protrudes, from the surface of the enclosure 11 (speaker holding portion 115, which will be described later) on the side of −Z direction, in a direction between −Z direction and +X direction, and is arranged opposite the output surface of an earphone speaker. The ear pad 12 has a hole 121 through which sound from the earphone speaker is output.

The multifunctional button 13 is an operation button that is formed on a side surface of the enclosure 11 (control portion holding portion 114, which will be described later). The multifunctional button 13 is a button with which each type of function of the headset 10 is selected and performed. The LED lamp 14 is formed next to the multifunctional button 13, and indicates the turning on and off of power and charging with the lighting, the extinguishing, the color and the like of the LED. The charging terminal 15 is formed next to the LED lamp 14, and is a terminal through which a code for charging the headset 10 is connected. The volume button 16 is an operation button that is formed on the side surface on the opposite side to the multifunctional button 13 of the enclosure 11, and is a button for adjusting the volume of sound output from the earphone speaker.

The enclosure 11 includes a main body portion 111, a boom arm portion 112 that extends out from one end of the main body portion 111 in +X direction and an arm head portion 113 that is formed at the top end (one end on the opposite side to the main body portion 111) of the boom arm portion 112. The enclosure 11 is formed by combining, for example, a plurality of resin molded members. The main body portion 111 is an example of the main body portion of the present invention. The boom arm portion 112 is an example of the coupling portion of the present invention. The arm head portion 113 is an example of the microphone holding portion of the present invention.

The main body portion 111 includes the control portion holding portion 114 that holds a control portion (not shown) controlling individual portions and the speaker holding portion 115 that holds the earphone speaker (not shown). The control portion holding portion 114 is formed substantially in the shape of a rectangular parallelepiped. The speaker holding portion 115 is a portion that protrudes, from the inside (the side of the speaking person) of the control portion holding portion 114, in −Z direction, and is a portion that is attached to the ear of the speaking person together with the ear pad 12. In the present embodiment, since the earphone speaker is disc-shaped, the speaker holding portion 115 is also disc-shaped to cover the earphone speaker. The speaker holding portion 115 may not protrude from the control portion holding portion 114. In this case, the ear pad 12 is preferably shaped to retain fitting to the ear. The speaker holding portion 115 and the ear pad 12 are an example of the earphone portion of the present invention.

The boom arm portion 112 is a portion that connects the main body portion 111 and the arm head portion 113, that extends in the direction of the front surface of the face of the speaking person and that holds wiring connecting the microphone 20 and the control portion. In FIGS. 1 to 3, the boom arm portion 112 linearly extends, in the +X direction, out from the center of the end portion of the control portion holding portion 114 on the side of +X direction. The boom arm portion 112 may be shaped along the outline of the speaking person. In other words, the boom arm portion 112 is formed in a shape extending out in +X direction and curved in −Z direction.

The arm head portion 113 is a portion which is formed substantially in the shape of, for example, a rectangular parallelepiped, and in which the direction of extension (the longitudinal direction) of the arm head portion 113 is curved to the side of −Z direction (the side of the cheek of the speaking person at the time of fitting) with respect to the direction of extension (+X direction) of the boom arm portion 112. This is because the arm head portion 113 is arranged along the cheek of the speaking person. When the boom arm portion 112 is short, even if the direction of extension of the arm head portion 113 is +X direction, which is the same as that of the boom arm portion 112, the arm head portion 113 can be arranged along the cheek of the speaking person.

The microphone 20 is held in the arm head portion 113. In the arm head portion 113, first and second sound holes 116 and 117 that are through-holes communicating with the microphone 20 are formed. The first sound hole 116 is arranged near the top end of the arm head portion 113; on the other hand, the second sound hole 117 is arranged near the end portion of the arm head portion 113 on the side of the boom arm portion 112.

The shape of the first and second sound holes 116 and 117 is not particularly limited, and may be formed, as shown in FIGS. 2 and 3, in the shape of an oval, a circle or a polygon. The number of sound holes is not limited, and may be one or three or more. When a differential microphone 20 of FIG. 10, which will be described later, is used, the first sound hole 116 is connected to a first microphone sound hole 27, which will be described later, and the second sound hole 117 is connected to a second microphone sound hole 28, which will be described later (see FIG. 6).

As shown in FIGS. 1 to 3, the arm head portion 113 has an upper side surface portion 113a, a lower side surface portion 113b, a front surface portion 113c, a back surface portion 113d and a top end side surface portion 113e. These are expressions with respect to the speaking person (user) to whom the headset 10 is fitted. Although here, a description will be given using, as an example, a case where the headset 10 is fitted to the right ear of the speaking person, it is also possible to satisfactorily use the headset 10 even when it is fitted to the left ear. The upper side surface portion 113a and the lower side surface portion 113b are an example of the two side surface portions of the present invention. The front surface portion 113c is an example of the front surface portion of the present invention. The first sound hole 116 and the second sound hole 117 are examples of the sound holes formed in the side surface portions of the present invention.

The upper side surface portion 113a has a surface that is upward (+Y direction) when the headset 10 is fitted to the speaking person. In the upper side surface portion 113a, the first and second sound holes 116 and 117 are formed. The first and second sound holes 116 and 117 may be formed in the lower side surface portion 113b.

The lower side surface portion 113b has a surface that is downward (−Y direction) when the headset 10 is fitted to the speaking person. The lower side surface portion 113b is opposite the upper side surface portion 113a, and has a congruent shape with the upper side surface portion 113a. The shape is not limited to the congruent shape; a similar shape may be used. The upper side surface portion 113a is opposite the lower side surface portion 113b such that the distance between them is narrowed as they extend to the side of the speaking person. In other words, they are tapered and are opposite each other such that the distance between their inner surfaces is narrowed as they extend to the side of the speaking person. Thus, at the time of assembly, the microphone 20 can be inserted from the side where the distance between the inner surface of the upper side surface portion 113a and the inner surface of the lower side surface portion 113b is wider. In other words, at the time of assembly, the microphone can be easily inserted, and the headset 10 can be easily assembled. How the headset 10 is assembled will be described later.

The front surface portion 113c has a surface opposite the speaking person when the headset 10 is fitted to the speaking person. The front surface portion 113c connects the end portion of the upper side surface portion 113a on the side of the speaking person and the end portion of the lower side surface portion 113b on the side of the speaking person.

The back surface portion 113d has a surface that is on the opposite side (the side of +Z direction) to the side of the speaking person when the headset 10 is fitted to the speaking person. The back surface portion 113d connects the end portion of the upper side surface portion 113a on the opposite side to the side of the speaking person and the end portion of the lower side surface portion 113b on the opposite side to the side of the speaking person.

The top end side surface portion 113e has a surface on the side of the top end (the side of +X direction) of the arm head portion 113. The top end side surface portion 113e connects the end portion of the upper side surface portion 113a on the side of the top end, the end portion of the lower side surface portion 113b on the side of the top end, the end portion of the front surface portion 113c on the side of the top end and the end portion of the back surface portion 113d on the side of the top end. The boundaries of the portions 113a to 113e are smoothly curved.

As described above, the number of sound holes provided in the arm head portion 113 is not limited. When one sound hole is provided in the arm head portion 113, it is preferably provided in the upper side surface portion 113a or the lower side surface portion 113b. On the other hand, when a plurality of sound holes are provided in the arm head portion 113, at least one of the sound holes is preferably provided in the upper side surface portion 113a or the lower side surface portion 113b, and the other sound holes may be provided in any of the side surface portions and the back surface portion except the front surface portion 113c, which faces the cheek of the speaking person. This is because the sound holes are prevented from being blocked by the cheek.

As described above, the arm head portion 113 includes the upper side surface portion 113a that is upward when the headset 10 is fitted to the speaking person, the lower side surface portion 113b that is downward when the headset 10 is fitted to the speaking person and the sound holes that are formed in the upper side surface portion 113a or the lower side surface portion 113b so as to communicate with the microphone 20. Hence, the sound holes (the first and second sound holes 116 and 117) that communicate with the microphone 20 are prevented from being blocked by the cheek of the speaking person. Thus, it is possible to satisfactorily maintain the sensitivity of the microphone 20.

As the microphone 20 described above, a differential microphone or an SMD (surface mount device) type in the shape of a rectangular parallelepiped can be preferably used. For example, a differential microphone as shown in FIG. 10 can be used. FIG. 10 is a cross-sectional view of an example of a differential microphone.

The differential microphone 20 includes a microphone enclosure 23 that is formed with a mounting portion (substrate) 21 and a lid portion 22 which covers the mounting portion 21 and that is formed substantially in the shape of a rectangular parallelepiped. Within the microphone enclosure 23, a first MEMS (micro electro mechanical system) chip 24, an unillustrated first ASIC (application specific integrated circuit), a second MEMS chip 25 and a second ASIC 26 are held. In the microphone enclosure 23, the first and second microphone sound holes 27 and 28 are formed.

The first and second MEMS chips 24 and 25 are formed with silicon chips, and include first and second diaphragms 241 and 251, respectively. A sound wave reaches the first diaphragm 241 from above through the first microphone sound hole 27, and a sound wave reaches the second diaphragm 251 from both above and below through the first and second microphone sound holes 27 and 28. In the first and second MEMS chips 24 and 25, when the sound waves cause the first and second diaphragms 241 and 251 to be vibrated, the capacitance obtained between fixed electrodes 242 and 252 is changed. Consequently, it is possible to acquire, as an electrical signals, the sound waves (sound signals) entering the first and second MEMS chips 24 and 25. In other words, the first and second MEMS chips 24 and 25 have the function of converting the sound signals into the electrical signals.

When sound is produced outside the differential microphone 20, the sound wave entering through the first microphone sound hole 27 reaches the upper surface of the first diaphragm 241 along a first sound path 31, and thus the first diaphragm 241 is vibrated. Thus, the capacitance of the first MEMS chip 24 is changed. The electrical signal acquired based on the change in the capacitance of the first MEMS chip 24 is amplified by an amplification circuit of the first ASIC (which is not shown but is present on the side of the back of the plane of the figure with respect to the first MEMS chip 26) and is output.

Moreover, when sound is produced outside the differential microphone 20, the sound wave entering through the first microphone sound hole 27 reaches the upper surface of the second diaphragm 251 along the first sound path 31, and the sound wave entering through the second microphone sound hole 28 reaches the lower surface of the second diaphragm 251 along a second sound path 32. Hence, the second diaphragm 251 is vibrated by the sound pressure difference between a sound pressure applied to the upper surface and a sound pressure applied to the lower surface. Thus, the capacitance of the second MEMS chip 25 is changed. The electrical signal acquired based on the change in the capacitance of the second MEMS chip 25 is amplified by an amplification circuit of the second ASIC 26 and is output.

If the distance from the sound source to the first diaphragm 241 is constant, the sound pressure applied to the first diaphragm 241 is constant no matter which direction the sound source is located. In other words, when the side of the first MEMS chip 24 is utilized, the differential microphone 20 has an omnidirectional characteristic in which sound waves entering in all directions are evenly received.

On the other hand, when the side of the second MEMS chip 25 is utilized, the differential microphone 20 does not have an omnidirectional characteristic but a bidirectional characteristic. If the distance from the sound source to the second diaphragm 251 is constant, when the sound source is present in a direction of 0° or 180° (the direction in which the first and second microphone sound holes 27 and 28 are connected), the sound pressure applied to the second diaphragm 251 is maximized. This is because the difference between the distance over which the sound wave reaches the lower surface of the second diaphragm 251 from the second sound hole 28 and the distance over which the sound wave reaches the upper surface of the second diaphragm 251 from the first sound hole 27 is maximized.

On the other hand, when the sound source is present in a direction of 90° or 270°, the sound pressure applied to the second diaphragm 251 is minimized (to zero). This is because the difference between the distance over which the sound wave reaches the lower surface of the second diaphragm 251 from the second sound hole 28 and the distance over which the sound wave reaches the upper surface of the second diaphragm 251 from the first sound hole 27 is changed to approximate zero. In other words, when the side of the second MEMS chip 25 is utilized, the differential microphone 20 has a high sensitivity with respect to the sound wave entering from a direction of 0° or 180°, and has a low sensitivity with respect to the sound wave entering from a direction of 90° or 270° (bidirectional characteristic).

As described above, the differential microphone 20 has both the function of a bidirectional microphone having excellent far-field noise reduction performance (obtained by using the signal acquired from the second MEMS chip 25) and the function of an omnidirectional microphone capable of receiving far-field sound (obtained by using the signal acquired from the first MEMS chip 24).

As the microphone, the configuration obtained by omitting the first MEMS chip 24 and the first ASIC described above may be adopted. As an example of this configuration, there is a differential microphone including a vibration portion that converts, based on the vibration of a diaphragm, a sound signal into an electrical signal, the first and second sound holes that face the outside, the first sound path along which the sound wave entering through the first sound hole is transmitted to the one of the surfaces of the diagram described above and the sound path along which the sound wave entering through the second sound hole is transmitted to the other surface of the diagram described above.

The structure of the arm head portion 113 will now be described with reference to FIGS. 4 to 7. Here, a description will be given using, an example, a case where the differential microphone 20 described above is used as the microphone.

As shown in FIGS. 4 to 6, the enclosure 11 including the arm head portion 113 is formed by assembling a first member 11a and a second member 11b together. The first member 11 a is an integrally molded member that includes the upper side surface portion 113a, the lower side surface portion 113b, the front surface portion 113c and the top end side surface portion 113e of the arm head portion 113, a portion 112a that includes the surface of the boom arm portion 112 on the side of the speaking person and a portion 111a that includes the surface of the main body portion 111 on the side of the speaking person.

On the other hand, the second member 11b is a member that includes the back surface portion 113d of the arm head portion 113, a portion 112b that includes the surface of the boom arm portion 112 on the opposite side to the side of the speaking person and a portion 111b that includes the surface of the main body portion 111 on the opposite side to the side of the speaking person.

The first member 11a and the second member 11b can be fixed by a method of utilizing elastic material to fit the convex portion into the concave portion, that is, a so-called snap-fitting. FIGS. 4 to 6 show a fixing portion 40 that performs fixing by snap-fitting.

On the second member 11b, two microphone fixing members 118 for fixing the differential microphone 20 are integrally molded. The microphone fixing members 118 are protrusions that are formed substantially in the shape of a rectangular parallelepiped and that protrude from the inner surface of the back surface portion 113d of the arm head portion 113 in the direction of the front surface portion 113c. The surfaces 118a of the microphone fixing members 118 on the side of the upper side surface portion 113a of the arm head portion 113 are formed substantially parallel to the inner surface of the upper side surface portion 113a of the arm head portion 113.

At the time of assembly, first, to the side of the first and second microphone sound holes 27 and 28 of the differential microphone 20, a gasket 41 (see FIG. 7) is adhered with a two-sided adhesive tape or the like. The gasket 41 is a plate member such as rubber, and is a member in which the holes of the same shapes as the first and second microphone sound holes 27 and 28 are formed. The gasket 41 has the function of removing a gap between the differential microphone 20 and the inner surface of the upper side surface portion 113a of the arm head portion 113.

Then, a two-sided adhesive tape or the like is adhered to the surface of the gasket 41 opposite the inner surface of the upper side surface portion 113a of the arm head portion 113. Then, the differential microphone 20 (including the gasket 41) is adhered within the arm head portion 113 of the first member 11 a such that the first and second microphone sound holes 27 and 28 are overlaid on the first and second sound holes 116 and 117 formed in the arm head portion 113.

Then, the first member 11a and the second member 11b are assembled together by the snap-fitting of the fixing portion 40. Thus, the surfaces 118a of the microphone fixing members 118 are pressed onto the surface (the surface of the differential microphone 20 on the side of the microphone fixing members 118) of the differential microphone 20 on the opposite side to the first and second sound holes 116 and 117. Consequently, the differential microphone 20 is pressed onto the side of the inner surface of the upper side surface portion 113a of the arm head portion 113.

As described above, the differential microphone 20 is fixed to the arm head portion 113 with the adhesive tape. Furthermore, the differential microphone 20 is fixed with the microphone fixing members 118 that press the surface of the differential microphone 20 on the opposite side to the side of the first and second sound holes 116 and 117 and that press the differential microphone 20 onto the side of the inner surface of the upper side surface portion 113a where the first and second sound holes 116 and 117 are formed.

In the configuration described above, the differential microphone 20 can be said to include the mounting portion (substrate) 21 that is provided substantially parallel to the upper side surface portion 113a. This is because the first and second sound holes 116 and 117 are formed in the upper side surface portion 113a (or the lower side surface portion 113b) of the arm head portion 113. The mounting portion 21 is arranged substantially parallel to the upper side surface portion 113a, and thus it is possible to narrow the distance between the upper side surface portion 113a and the lower side surface portion 113b as compared with the distance between the front surface portion 113c and the back surface portion 113d. Consequently, with the headset 10 fitted to the speaking person, the arm head portion 113 appears thin when seen from the front side, and thus a good design is provided.

In the configuration described above, since only two members, that is, the first and the second members 11a and 11b constitute the arm head portion 113, it is possible to realize the minimum number of components and also reduce the number of assembly steps. At the time of assembly, the second member 11b is only fitted into the first member 11a after the differential microphone 20 is adhered or placed therewithin, and thus the assembly is easily performed. Unlike FIG. 9, which will be described later, the arm head portion 113 is not separated into left and right parts, and thus a division line is invisible, with the result that a good design is provided.

In the configuration described above, the inner surface of the upper side surface portion 113a and the inner surface of the lower side surface portion 113b in the arm head portion 113 are opposite each other such that the distance therebetween is narrowed as the they extend to the side of the speaking person. Thus, at the time of assembly, the microphone 20 can be inserted from the side of the back surface portion 113d where the distance between the inner surface of the upper side surface portion 113a and the inner surface of the lower side surface portion 113b is wider. In other words, at the time of assembly, the microphone is easily inserted, and the headset 10 is easily assembled.

### Second Embodiment

FIG. 8 is a cross-sectional view of the arm head portion of a headset according to a second embodiment. FIG. 8 shows a cross section in the same position as in FIG. 7. The second embodiment differs from the first embodiment in that a microphone fixing member 42 shown in FIG. 8 is a member separate from the arm head portion 113. The action and effects of the microphone fixing member 42 are the same as those of the microphone fixing members 118 according to the first embodiment. The other configurations of the second embodiment are the same as those of the first embodiment, and thus their description will not be repeated

The microphone fixing member 42 is a plate-shaped member whose front and back surfaces are tapered. The microphone fixing member 42 is sandwiched between the differential microphone 20 and the inner surface of the lower side surface portion 113b of the arm head portion 113. Thus, the differential microphone 20 is fixed so that it is not displaced.

At the time of assembly, the gasket 41 is first adhered to the side of the first and second microphone sound holes 27 and 28 of the differential microphone 20 with a two-sided adhesive tape or the like. Then, a two-sided adhesive tape or the like is adhered to the surface of the gasket 41 opposite the inner surface of the upper side surface portion 113a of the arm head portion 113. Then, the differential microphone 20 (including the gasket 41) is adhered within the arm head portion 113 of the first member 11 a such that the first and second microphone sound holes 27 and 28 are overlaid on the first and second sound holes 116 and 117 formed in the arm head portion 113.

Then, between the differential microphone 20 and the inner surface of the lower side surface portion 113b of the arm head portion 113, the microphone fixing member 42 is inserted. Thus, the microphone fixing member 42 presses the surface (the surface of the differential microphone 20 on the side of the microphone fixing member 42) of the differential microphone 20 on the opposite side to the first and second sound holes 116 and 117. Consequently, the differential microphone 20 is pressed onto the side of the inner surface of the upper side surface portion 113a of the arm head portion 113. Then, the first member 11a and the second member 11b where the microphone fixing members 118 are not formed are assembled together by the snap-fitting of the fixing portion 40.

As described above, the differential microphone 20 is fixed with the microphone fixing member 42 that presses the surface of the differential microphone 20 on the opposite side to the side of the first and second sound holes 116 and 117, and that presses the differential microphone 20 onto the side of the inner surface of the upper side surface portion 113a where the first and second sound holes 116 and 117 are formed.

In the configuration described above, as in the first embodiment, the differential microphone 20 can be said to include the mounting portion (substrate) 21 that is provided substantially parallel to the upper side surface portion 113a. This is because the first and second sound holes 116 and 117 are formed in the upper side surface portion 113a (or the lower side surface portion 113b) of the arm head portion 113. The mounting portion 21 is arranged substantially parallel to the upper side surface portion 113a, and thus it is possible to narrow the distance between the upper side surface portion 113a and the lower side surface portion 113b as compared with the distance between the front surface portion 113c and the back surface portion 113d. Consequently, with the headset 10 fitted to the speaking person, the arm head portion 113 appears thin when seen from the front side, and thus a good design is provided.

### Third Embodiment

FIG. 9 is an exploded perspective view of an arm head portion and its vicinity in a headset according to a third embodiment. The third embodiment differs from the first embodiment in that the portion of the arm head portion 113 of the first member 1 la according to first embodiment is divided into two separate parts, and that they are formed with an upper side surface side member 11c and a lower side surface side member 11d shown in FIG. 9. Moreover, the third embodiment differs from the first embodiment in that two microphone fixing members 119 shown in FIG. 9 are formed in the inner surface of the lower side surface portion 113b of the arm head portion 113. The other configurations of the third embodiment are the same as those of the first embodiment, and thus their description will not be repeated.

The arm head portion 113 is formed with the upper side surface side member 11c, the lower side surface side member 11d and the top end of the second member 11b where the microphone fixing members 118 are not formed. The upper side surface side member 11c is formed with the upper side surface portion 113a, the half of the front surface portion 113c on the side of the upper side surface portion 113a and the half of the top end side surface portion 113e on the side of the upper side surface portion 113a. On the other hand, the lower side surface side member 11d is formed with the lower side surface portion 113b, the half of the front surface portion 113e on the side of the lower side surface portion 113b and the half of the top end side surface portion 113e on the side of the lower side surface portion 113b.

In the inner surface of the lower side surface portion 113b of the lower side surface side member 11d, the two microphone fixing members 119 for fixing the differential microphone 20 are integrally molded. The microphone fixing members 119 are protrusions that protrude from the inner surface of the lower side surface portion 113b in the direction of the upper side surface portion 113a. The surfaces 119a of the microphone fixing members 119 on the side of the upper side surface portion 113a of the arm head portion 113 are formed substantially parallel to the inner surface of the upper side surface portion 113a of the arm head portion 113.

At the time of assembly, the gasket 41 is first adhered to the side of the first and second microphone sound holes 27 and 28 of the differential microphone 20 with a two-sided adhesive tape or the like. Then, a two-sided adhesive tape or the like is adhered to the surface of the gasket 41 opposite the inner surface of the upper side surface portion 113a of the upper side surface side member 11c. Then, the differential microphone 20 (including the gasket 41) is adhered within the upper side surface side member 11c such that the first and second microphone sound holes 27 and 28 are overlaid on the first and second sound holes 116 and 117 formed in the upper side surface side member 11c.

Then, the upper side surface side member 11c to which the differential microphone 20 is adhered and the lower side surface side member 11d are assembled together with an adhesive or such as by snap-fitting. Thus, the surfaces 119a of the microphone fixing members 119 presses the surface (the surface of the differential microphone 20 on the side of the microphone fixing members 119) of the differential microphone 20 on the opposite side to the first and second sound holes 116 and 117. Consequently, the differential microphone 20 is pressed onto the side of the inner surface of the upper side surface portion 113a of the arm head portion 113. Then, the member where the upper side surface side member 11c and the lower side surface side member 11d are assembled together and the second member 11b where the microphone fixing members 118 are not formed are assembled together by the snap-fitting of the fixing portion 40.

When the upper side surface side member 11c to which the differential microphone 20 is adhered and the lower side surface side member 11d are assembled together with an adhesive or such as by snap-fitting, the fixing portion 40 may be engaged by sandwiching the second member 11b from its sides. With this method, it is possible to omit the step of assembling together the member where the upper side surface side member 11c and the lower side surface side member 11d described above are assembled together and the second member 11b where the microphone fixing members 118 are not formed.

As described above, the differential microphone 20 is fixed with the microphone fixing members 119 that press the surface of the differential microphone 20 on the opposite side to the side of the first and second sound holes 116 and 117, and that presses the differential microphone 20 onto the side of the inner surface of the upper side surface portion 113a where the first and second sound holes 116 and 117 are formed.

In the configuration described above, as in the first embodiment, the differential microphone 20 can be said to include the mounting portion (substrate) 21 that is provided substantially parallel to the upper side surface portion 113a. This is because the first and second sound holes 116 and 117 are formed in the upper side surface portion 113a (or the lower side surface portion 113b) of the arm head portion 113. The mounting portion 21 is arranged substantially parallel to the upper side surface portion 113a, and thus it is possible to narrow the distance between the upper side surface portion 113a and the lower side surface portion 113b as compared with the distance between the front surface portion 113c and the back surface portion 113d. Consequently, with the headset 10 fitted to the speaking person, the arm head portion 113 appears thin when seen from the front side, and thus a good design is provided.

### Others

In the first to third embodiments, the two-sided adhesive tape can be omitted.

Even in this case, the differential microphone 20 is fixed with the microphone fixing member, and thus the position of the differential microphone 20 is prevented from being displaced. The gasket 41 can also be omitted. In this case, the differential microphone 20 and the inner surface of the upper side surface portion 113a of the arm head portion 113 may or may not be adhered with a two-sided adhesive tape or the like.

What is claimed is:

1. A headset that includes an enclosure holding a speaker and a microphone,
wherein the enclosure comprises:
a main body portion which holds the speaker and in which an earphone portion attached to an ear is provided;
a microphone holding portion which holds the microphone; and
a coupling portion which couples the main body portion to the microphone holding portion, and
when a side where the earphone portion is provided is a front surface side of the enclosure, in a side surface portion of the microphone holding portion, a sound hole communicating with the microphone is formed.

2. The headset of claim 1,
wherein the microphone holding portion includes two side surface portions which are substantially parallel to a direction in which the coupling portion extends out from the main body portion, and
the sound hole is formed in at least one of the two side surface portions.

3. The headset of claim 2,
wherein the microphone includes a substrate which is provided substantially parallel to the one of the side surface portions where the sound hole is formed.

4. The headset of claim 2,
wherein the two side surface portions are opposite each other such that a distance between the side surface portions is narrowed as the side surface portions extend to the front surface side.

5. The headset of claim 2,
wherein the microphone holding portion is formed by assembling a first member and a second member together,
the first member is an integrally molded member which includes the two side surface portions and a front surface portion that couples the two side surface portions and
the second member is a member which includes a back surface portion provided on an opposite side to the front surface portion.

6. The headset of claim I, further comprising:
a microphone fixing member which presses the microphone onto the side surface portion where the sound hole is formed.

7. The headset of claim 6,
wherein the microphone fixing member is molded integrally with the microphone holding member.

8. The headset of claim 1,
wherein the microphone is a differential microphone which has two microphone sound holes, and
a number of the sound holes formed in the microphone holding portion is two.
